(19) United States
(12) Patent Application Publication
(10) Pub. No.: US 2023/0107119 A1
(43) Pub. Date: Apr. 6, 2023

(54) METHOD FOR PRODUCING AN ACTIVE PART FOR A ROTARY ELECTRIC MACHINE, ACTIVE PART FOR A ROTARY ELECTRIC MACHINE, AND ROTARY ELECTRIC MACHINE

(71) Applicant: Valeo eAutomotive Germany GmbH, Erlangen (DE)

(72) Inventors: Boris Dotz, Erlangen (DE); Christian Finger-Albert, Erlangen (DE); Sebastian Beetz, Erlangen (DE); David Förster, Erlangen (DE)

(73) Assignee: Valeo eAutomotive Germany GmbH, Erlangen (DE)

(21) Appl. No.: 17/957,460

(22) Filed: Sep. 30, 2022

(30) Foreign Application Priority Data
Oct. 1, 2021 (EP) 21200533.4

(51) Int. Cl. B23K 26/08; H02K 3/04; H02K 15/085

(52) U.S. Cl. CPC B23K 26/0823; H02K 3/04; H02K 15/085; B23K 2101/36

(57) ABSTRACT

A method for producing an active part (1) for a rotary electric machine (101), comprising the following steps:
providing a core (2) for the active part (1) and shaped conductors (6) inserted into the core;
joining together, in each case, two of the end areas (9) so that the two end areas (9) form a pair (10); and
welding each pair (10) of the end areas (9) by means of a laser beam which is guided on the end areas (9) of the pair (10) along a first trajectory (13).

Method for producing an active part for a rotary electric machine, active part for a rotary electric machine, and rotary electric machine

The invention relates to a method for producing an active part for a rotary electric machine, comprising the following steps: providing a core for the active part and shaped conductors inserted into the core, wherein the core has an end face, a further end face opposite the end face, and a plurality of slots which are arranged circumferentially and in which the shaped conductors are arranged, wherein the shaped conductors extend from the end face to the further end face and each have a free end which protrudes at the end face and has an end area; joining together, in each case, two of the end areas so that the two end areas form a pair; and welding each pair of the end areas by means of a laser beam which is guided on the end areas of the pair along a first trajectory and a second trajectory, wherein the first trajectory and the second trajectory each have a start point and an end point which is different from the start point.

In addition, the invention relates to an active part for a rotary electric machine, and to a rotary electric machine.

WO 2019/159737 A1 discloses coil segments inserted into a core. End portions of the coil segments are joined against each other and surfaces of the end portions forming an area with a boundary are irradiated by laser light and welded. The laser light is guided over several trajectories.

When welding end portions of shaped conductors inserted into a core, there is a requirement to form a stable welded joint with good electrical conductivity. Furthermore, the energy input into the end areas should be as low as possible in order to prevent the coating of coated shaped conductors from melting.

The object of the invention is to describe a possibility for producing an active part for a rotary electric machine which is improved compared to the prior art.

In accordance with the invention, this object is achieved in the case of a method of the type mentioned at the outset in that the first trajectory and the second trajectory run concavely between the start point and the end point.

The method according to the invention for producing an active part for a rotary electric machine comprises a step of providing a core for the active part and shaped conductors. The shaped conductors are inserted into the core. The core has an end face. The core further comprises a further end face. The further end face is opposite the end face. The core also has a plurality of slots. The slots are arranged circumferentially. The shaped conductors are arranged in the slots. The shaped conductors extend from the end face to the further end face. The shaped conductors each have a free end. The free end has an end area. The method according to the invention further comprises a step of joining together, in each case, two of the end areas so that the two end areas form a pair. The method further comprises a step of welding each pair of the end areas. The welding is performed by means of a laser beam, The laser beam is guided on the end areas of the pair. The laser beam is guided along a first trajectory. The laser beam is further guided along a second trajectory. The first trajectory and the second trajectory each have a start point. The first trajectory and the second trajectory each further have an end point which is different from the start point. The first trajectory and the second trajectory run concavely between the start point and the end point.

Due to the concave course of the trajectories of the laser beam provided in accordance with the invention, corner regions of the end areas as well as central or inner portions of the end areas can be covered by the laser beam. Thus, a careful weld seam or weld area can be formed, which efficiently utilizes the material of the end portions. At the same time, a lower energy input into the shaped conductors can be achieved, for example in comparison to a closed, rectangular trajectory along the edges of the end areas known from the prior art.

Preferably, the core is formed from a plurality of layered and/or electrically insulated individual laminations. In this respect, the core can also be referred to as a laminated core. The slots can be formed as through-openings of the core, which extend from the end face to the further end face.

The shaped conductors are preferably made of copper. The shaped conductors can be formed as a multi-bent wire, which in particular has a U-shape or a V-shape. The shaped conductors can have a further free end which is opposite the free end and which protrudes from the end face and also has an end area. The free ends preferably protrude from different slots on the end face. Preferably, one or more current paths are formed by welding together different shaped conductors. The current paths are configured to generate a magnetic field when a current is applied to produce an electromotive force of the rotary electric machine.

The shaped conductors can have a rectangular or rounded rectangular cross-sectional area at the or each free end. The cross-sectional area can have two opposite long sides and two opposite narrow sides. Preferably, the end areas are joined together in such a way that one long side of each of the shaped conductors of the pair face each other. The shaped conductors can have an outer electrically insulating surface layer that surrounds an electrically conductive material of the shaped conductors. It can be provided that the electrically conductive material is exposed at the tree end or at the free ends so that the surface layer is not damaged by the laser beam during welding.

For example, in particular, the method for producing an active part for a rotary electric machine can comprise the following steps:

providing a core for the active part and shaped conductors. The shaped conductors are inserted into the core. The core has an end face. The core can further have a further end face. The further end face can be opposite the end face. The core can further have a plurality of slots. The slots are arranged circumferentially. The shaped conductors are arranged in the slots. The shaped conductors extend from the end face to the further end face. The shaped conductors each have a free end. The free end has an end area. The method according to the invention can further comprise a step of joining together, in each case, two of the end areas so that the two end areas form a pair. The method can further comprise a step of welding each pair of the end areas. The welding can be performed by means of a laser beam. The laser beam can be guided on the end areas of the pair. The laser beam can be guided along a first trajectory. The laser beam can further be guided along a second trajectory. The first trajectory and the second trajectory can each have a start point. The first trajectory and the second trajectory can each further have an end point which is different from the start point. An edge of the end area of each shaped conductor can consist of an inner edge portion and an outer edge portion, wherein the inner edge portion of one of the end areas of each pair of the end areas can run along the inner edge portion of the other end area of the pair of end areas in question, and between the inner edge portions a boundary region, in particular formed by a gap between the inner edge portions or a contact of the inner edge portions, can run. Each trajectory can run over an area at the edge of which the outer edge portions lie and which encloses the boundary region. The area can be bounded at least in portions by the narrow sides and/or by the long sides not facing each other. The first trajectory can in particular run, in each case, from a start point, which can be located in the outer edge portion of the end area, via the inner edge portion of the end area to the end point, which can be located in the outer edge portion of the end area. The second trajectory can in particular run, in each case, from a start point, which can be located in the outer edge portion of the other end area, via the inner edge portion of the other end area to the end point, which can be located in the outer edge portion of the other end area.

Specifically, in the method according to the invention, it can be provided that an edge of the end area of each shaped conductor consists of an inner edge portion and an outer edge portion, wherein the inner edge portion of one of the end areas of each pair of the end areas runs along the inner edge portion of the other end area of the pair of the end areas in question, and between the inner edge portions a boundary region, in particular formed by a gap between the inner edge portions or a contact of the inner edge portions, extends. Each trajectory can run over an area at the edge of which the outer edge portions lie and which encloses the boundary region. The area can be bounded at least in some portions by the narrow sides and/or by the long sides not facing each other.

The midpoint of the first trajectory and of the second trajectory can be closer to a midpoint of the area than the start point and the end point of the trajectory. In other words, the trajectory can be open towards the edge of the area. In particular, the midpoint of a respective trajectory is equidistant from the start point and the end point.

Furthermore, the area can be subdivided into a first to fourth quadrant. The quadrants can have an identical area. A common boundary line of the first and second quadrants and a common boundary line of the third and fourth quadrants can lie on a first line. A common boundary line of the first and fourth quadrants and a common boundary line of the second and third quadrants can lie on a second line intersecting the first line, in particular perpendicularly. Preferably, each corner of the area or of the pair of end portions lies in exactly one of the quadrants. The four quadrants can be in point contact at the intersection of the first line and the second line.

In a preferred embodiment, the start point and the end point of the first trajectory are located in two different quadrants lying on the same side of the first line, and the start point and the end point of the second trajectory are located in different quadrants lying on the other side of the first line.

According to one variant, the first line runs along the boundary portion. According to an alternative, second variant, the second line runs along the boundary portion.

It can further be provided that the first trajectory and the second trajectory each run entirely within those quadrants in which the start point and the end point of the trajectory lie.

Intersection points of each of the first trajectory and of the second trajectory with the second line can be closer to the first line than an intersection point of an imaginary straight line, which runs through the start point and the end point of the trajectory, with the second line.

Furthermore, each quadrant can be diagonally divided into two octants. A common boundary line of each two adjacent octants can run towards an intersection of the first line with the second line. Figuratively speaking, the common boundary lines of the adjacent octants form an eight-pointed star.

Here, the first and second trajectories can each extend over a greater distance within the non-adjacent octants of the quadrants in which the trajectory lies than within the adjacent octants of the quadrants in which the trajectory lies.

Alternatively or additionally, an energy input of the laser beam along the first and second trajectories within the non-adjacent octants of the quadrants in which the trajectory lies can be greater than within the adjacent octants of the quadrants in which the trajectory lies.

It is further possible for the first trajectory and the second trajectory to extend in some portions along the common boundary lines of the adjacent octants of the quadrants in which the trajectory lies. Additionally, the trajectory can connect the two boundary lines intersecting the first line or the second line. The connection between the common boundary lines can be straight.

The first and second trajectories can be mirror-symmetrical with respect to the boundary region or with respect to a line of symmetry that is shifted in parallel in relation to the boundary region.

Generally, in the method according to the invention, it can be provided that the first and the second trajectory each describe an arched curve, in particular an arc of a circle, an arc of an ellipse, a parabola or a hyperbola, on the area.

Alternatively, it can be provided that the first and second trajectories can each have or consist of first to third straight portions, wherein the first straight portion extends from the start point, the third straight portion extends towards the end point, and the second straight portion connects the first straight portion to the second straight portion. The second straight portion can form a right angle with each of the first straight portion and the third straight portion. It is also possible that the second straight portion can form an angle of more than 90° with the first straight portion and the third straight portion, for example at least 100°, preferably at least 120°, particularly preferably at least 130°.

In a development of the method according to the invention, it can be provided that the laser beam in the welding step is further guided along a third trajectory which lies, in particular without overlapping, between the first and second trajectories and has a start point and an end point which is different from the start point. In this way, an energy input in the region of the middle of the pair can be increased, since an energy input in this region has a smaller influence on the coating of the shaped conductors. The third trajectory can intersect the boundary region and/or can run straight.

In the method according to the invention, a laser device generating the laser beam can be used, the laser device having a deactivated state, in which the laser beam is switched off or which has a deactivated state for melting a material, and an activated state, in which the laser beam can melt the material of the shaped conductor. The welding step can comprise the following steps for each trajectory: aligning the laser device with the start point of the trajectory in the deactivated state; guiding the laser beam in the activated state of the laser device from the start point along the trajectory to the end point of the trajectory; wherein, between the aligning and the guiding, the laser device is transferred from the deactivated state to the activated state when the laser device is aligned with the start point of the trajectory, and is transferred from the activated state to the deactivated state when the guiding has reached the end point of the trajectory.

The active part can be a stator or a rotor. in particular, the rotor is externally excited. The rotor can also be permanently excited.

The object of the invention is further achieved by an active part for a rotary electric machine obtained by the method according to the invention and/or comprising: a core and shaped conductors inserted into the core, wherein the core has an end face, a further end face opposite the end face, and a plurality of slots which are arranged circumferentially and in which the shaped conductors are arranged, wherein the shaped conductors extend from the end face to the further end face and each have a free end which protrudes at the end face and which in each case has an end area, wherein each two of the end areas are joined together in such a way that the two end areas form a pair, wherein each pair of the end areas of the pair are welded along a first trajectory and a second trajectory on the end areas, wherein the first trajectory and the second trajectory each have a start point and an end point which is different from the start point, wherein the first trajectory and the second trajectory run concavely between the start point and the end point. A weld seam can be formed along the trajectories.

The object of the invention is further achieved by a rotary electric machine comprising a first active part according to the invention and a second active part, in particular according to the invention, wherein the electric machine is configured to drive a vehicle. The vehicle can be a hybrid vehicle or a battery electric vehicle.

All the explanations regarding the method according to the invention can be transferred analogously to the active part according to the invention and the rotary electric machine according to the invention, and therefore they can also achieve the advantages described above.

Further advantages and details of the present invention will become apparent from the exemplary embodiments described below and from the drawings. These are schematic representations and show:

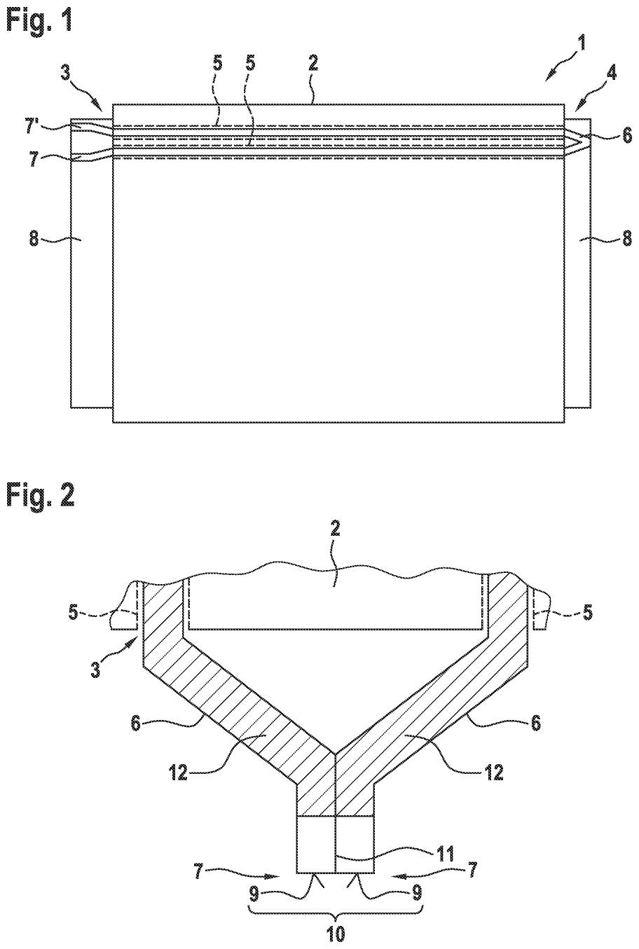

FIG. 1 a schematic sketch of a first exemplary embodiment of the active part according to the invention;

FIG. 2 a detailed view of two shaped conductors in the region theft free ends according to the first exemplary embodiment;

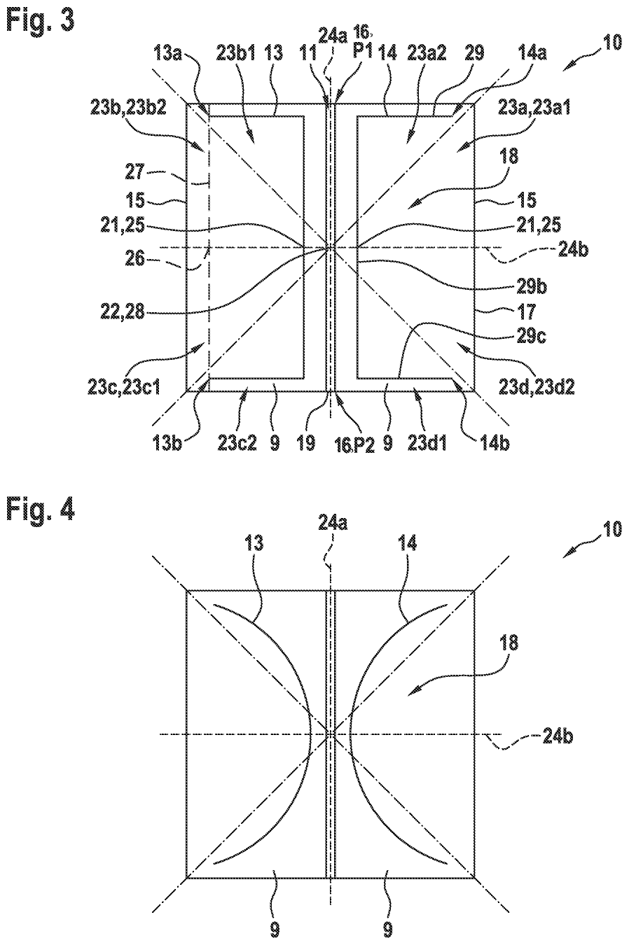

FIG. 3 an end-face view of the end areas of one of the pairs;

FIGS. 4 to 8 in each case an end-face view of the end area of one of he pairs according to a further exemplary embodiment; and

FIG. 9 a schematic sketch of a vehicle with an exemplary embodiment of the electric machine according to the invention.

FIG. 1 is a schematic sketch of a first exemplary embodiment of active part 1 for a rotary electric machine 101 (cf. FIG. 9).

The active part 1 comprises a core 2, which can be formed in a generally known manner from a plurality of layered individual laminations (not shown) that are electrically insulated from one another and in this case can also be understood as a laminated core. The core 2 has an end face 3 and a further end face 4 opposite the end face 3. The core 2 also has a plurality of slots 5 arranged circumferentially which extend in the axial direction from the end face 3 to the further end face 4 and pass completely through the core 2 in the axial direction. Only two of the slots 5 are shown schematically in FIG. 1.

The active part 1 also comprises, inserted into the core 2, a plurality of shaped conductors 6, of which only one is shown in FIG. 1. The shaped conductors 6 extend from the end face 3 to the further end face 4 and each have a free end 7. In the present exemplary embodiment, the shaped conductor 6 is made of copper by way of example and is formed by a wire bent multiple times. In this case, the shaped conductor 6 extends from the free end 7 at the end face 3 in the axial direction to the further end face 4, has a 180-degree bend at the further end face 4 and extends back from the further end face 4 through another slot 5 to the end face 3. At the end face 3, the shaped conductor 6 has a further free end 7′. The shaped conductor 6 accordingly has a U-shape or V-shape and can also be understood as a conductor segment of a hair pin winding. At both end faces 3, 4 the shaped conductors form winding heads 8 as shown merely schematically.

FIG. 2 is a detailed view of two shaped conductors 6 in the region of heir free ends 7 according to the first exemplary embodiment.

The shaped conductors 6 protrude from the core 2 at its end face 3. The free ends 7 each have an end area 9 which extends substantially perpendicular to the axial direction or perpendicular to the direction in which the shaped conductors extend. The end areas 9 are joined together to form the pair 10. A gap between the end areas 9 or contact between the end areas 9 forms a boundary region 11.

Each pair 10 of end areas 9 is welded together by means of a laser beam so that the free ends 7 or the shaped conductors 6 are electrically conductive and mechanically connected to each other. By welding, one or more current paths are formed, which are configured to generate a magnetic field for producing an electromotive force of the rotary electric machine 101 (see FIG. 9) when a current is applied.

FIG. 2 also shows schematically, by hatching, an outer electrically insulating surface layer 12 of the shaped conductors 6. The surface layer 12 surrounds an electrically conductive material of the shaped conductors 6. Only at the free ends 7, T is the electrically conductive material exposed, and therefore the surface layer 12 is not damaged by the thermal energy input of the laser beam.

FIG. 3 is an end-face view of the end areas 9 of one of the pairs 10 according to the first exemplary embodiment.

Each pair 10 is welded on the end areas 9 along a first trajectory 13 and a second trajectory 14. The trajectories 13, 14 each have a start point 13a, 14a and an end point 13b, 14b. The first trajectory 13 is concave between its start point 13a and its end point 13b. Similarly, the second trajectory 14 is concave between its start point 14a and its end point 14b.

One edge 15 of the end area 9 of each shaped conductor 6 consists of an inner edge portion 16 and an outer edge portion 17. In FIG. 3, the start and end of the inner edge portion 16 are marked with arrows P1, P2. The inner edge portion 16 of one of the end areas 9 of each pair runs along the inner edge portion 16 of the other end area 9 of the pair 10 in question. The boundary region 11 runs between the inner edge portions 16. Each trajectory 13, 14 runs over an area 18, at the edge 19 of which the outer edge portions 17 lie. The area 18 also includes the boundary region 11. A midpoint 21 of each trajectory 13, 14 is closer to a midpoint 22 of the area 18 than the trajectory start point 13a, 14a and trajectory end point 14a, 14b.

The area 18 is further divided into first to fourth quadrants 23a, 23b, 23c, 23d. A common boundary line of the first quadrant 23a and the second quadrant 23b lies on a first line 24a. A common boundary line of the third quadrant 23c and the fourth quadrant 23d further lies on the first line 24a. On a second line 24b lies a common boundary line of the first and fourth quadrants 23a, 23d and a common boundary line of the second and third quadrants 23b, 23c. The quadrants 23a-d are named according to their order in a counter-clockwise sense when looking at the end areas 9 from the end face, The first line 24a intersects the second line 24b perpendicularly and runs along the boundary portion 11.

The start point 13a and the end point 13b of the first trajectory 13 are located in two different quadrants lying on the same side of the first line 24a, namely in the second and third quadrants 23b, 23c. The start point 14a and the end point 14b of the second trajectory 14 lie in different quadrants located on the other side of the first line 24b, namely in the first and fourth quadrants 23a, 23b. In this case, the first trajectory 13 and the second trajectory 14 run entirely within those quadrants 23a-d in which their start point 13a, 14a and their end point 13b, 14b lie.

It can also be seen that an intersection point 25 of the first trajectory 13 with the second line 24b is closer to the first line 24a than an intersection point 26 of an imaginary straight line 27 through the start point 13a and the end point 13b with the second line 24b. Likewise, an intersection point of the second trajectory 14 with the second line 24b is closer to the first line 24a than an intersection point of an imaginary straight line through the start point 14a and the end point 14b with the second line 24b, wherein in FIG. 3, for the sake of clarity, the intersection points and the straight line with respect to the second trajectory 14 have not been marked.

FIG. 3 further shows that each quadrant 23a-d is diagonally divided into two octants 23a1, 23a2, 23b1, 23b2, 23c1, 23c2, 23d1, 23d2. A common boundary line of two adjacent octants 23a1 to 23d2 runs towards an intersection point 28 of the first line 24a with the second line 24b. The first trajectory 13 lies over a greater distance within the non-adjacent octants 23b1, 23c2 of the quadrants 23b, 23c than within the adjacent octants 23b2, 23c1 of the quadrants 23b, 23c. The second trajectory 14 lies over a greater distance within the non-adjacent octants 23a2, 23d1 of the quadrants 23a, 23d than within the adjacent octants 23a1, 23d2 of the quadrants 23a, 23d.

According to the first exemplary embodiment, the first trajectory 13 and the second trajectory 14 each comprise a first straight portion 29a, a second straight portion 29b and a third straight portion 29c, which are only drawn for the second trajectory 14 in FIG. 3 for clarity. The first straight portion 29a extends from the start point 13a, 14a. The third straight portion 29c extends towards the end point 13b, 14b. The second straight portion 29b connects the first straight portion 29a to the third straight portion 29c. Further, the first straight portion 29a forms a right angle with the second straight portion 29b, and the second straight portion 29b forms a right angle with the third straight portion 29c.

According to the first exemplary embodiment, the first trajectory 13 and the second trajectory 14 further run mirror-symmetrically with respect to the first line 24a and with respect to the boundary portion 11, respectively.

The active part 1 can be formed as a stator 102 or as a rotor 103 (cf. FIG. 9).

Further exemplary embodiments of the active part 1 are described below. Like or equivalent components are provided with identical reference signs.

FIG. 4 is an end-face view of the end areas 9 of one of the pairs 10 according to a second exemplary embodiment of the active part 1 to which all explanations regarding the first exemplary embodiment can be transferred except for the deviations described below. In the second exemplary embodiment, instead of the straight portions 29a-c (see FIG. 3), the trajectories 13, 14 each describe an arched curve, for example an arc of a circle, an arc of an ellipse, a parabola or a hyperbola on the area 18.

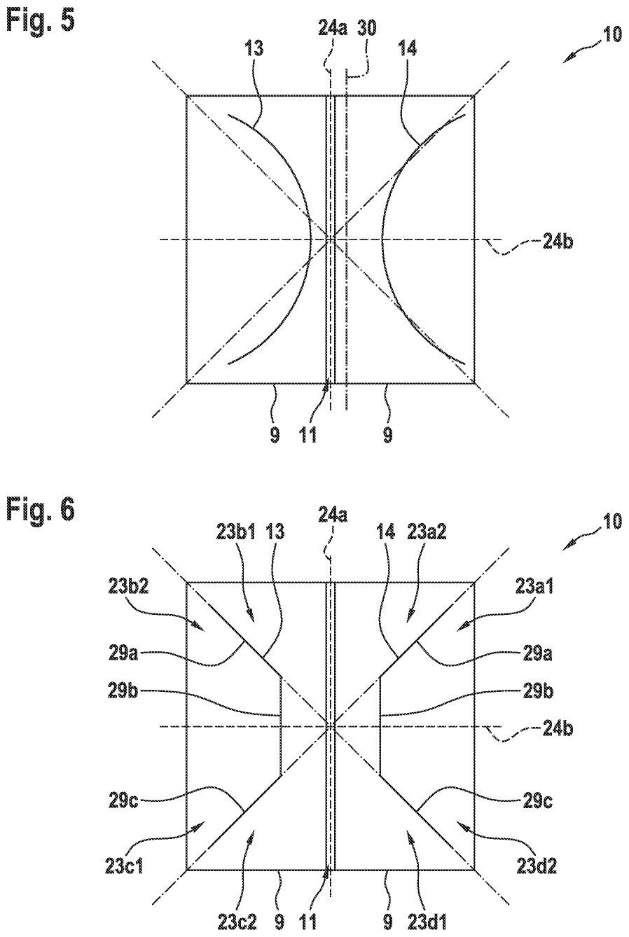

FIG. 5 is an end-face view of the end areas 9 of one of the pairs 10 according to a third exemplary embodiment of the active part 1, to which all explanations regarding the second exemplary embodiment can be transferred except for the deviations described below. In the third exemplary embodiment, the first trajectory 13 and the second trajectory 14 do not run mirror-symmetrically with respect to the first line 24a or with respect to the boundary portion 11, but mirror-symmetrically with respect to a straight line 30 that is shifted in parallel in relation to the first line 24a or the boundary portion 11.

FIG. 6 is an end-face view of the end areas 9 of one of the pairs 10 according to a fourth exemplary embodiment of the active part 1, to which all explanations regarding the first exemplary embodiment can be transferred except for the deviations described below. In the fourth exemplary embodiment, an angle greater than 90° is formed between the first straight portion 29a forms and the second straight portion 29b and also between the second straight portion 29b and the third straight portion 29c. In the present case, the angle is 135°. The first and third straight portions 29a, 29c also run along the boundary lines of adjacent octants 23a1 to 23d2.

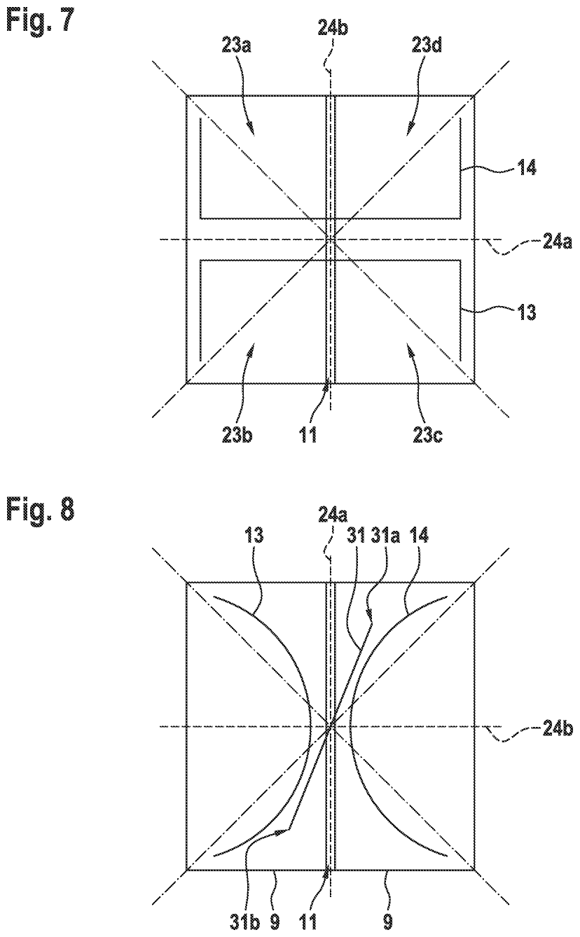

FIG. 7 is an end-face view of the end areas 9 of one of the pairs 10 according to a fifth exemplary embodiment of the active part 1, to which all explanations regarding the first exemplary embodiment can be transferred except for the deviations described below. In the fifth exemplary embodiment, the second line 24b runs along the boundary portion 11. As a result, the trajectories 13, 14 extend over the boundary portion and the naming of the quadrants 23a-d is rotated by 90°—in this example counter-clockwise—compared to FIG. 1.

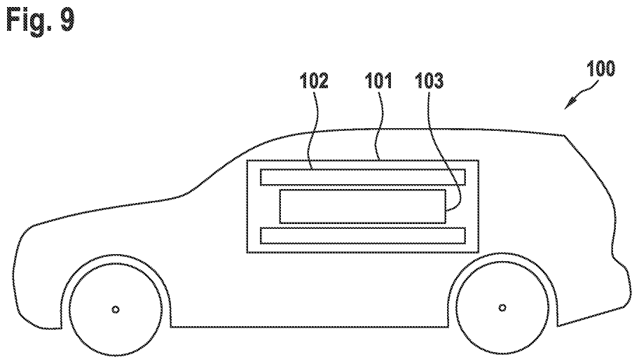

FIG. 8 is an end-face view of the end areas 9 of one of the pairs 10 according to a sixth exemplary embodiment of the active part 1, to which all explanations regarding the second exemplary embodiment can be transferred except for the deviations described below. In the sixth exemplary embodiment, a third trajectory 31 is provided which lies between the first and second trajectories 13, 14 without overlapping and has a start point 31a and an end point 31b different from the start point. In this example, the third trajectory 31 runs straight and intersects the boundary region 11.

According to further exemplary embodiments of the active part 1, the mirror symmetry of the third exemplary embodiment is applied to the trajectories according to the first, fourth, fifth or sixth exemplary embodiment.

According to further exemplary embodiments of the active part 1, the second line 24b runs along the boundary region 11 as described in the fifth exemplary embodiment and the trajectories 13, 14, 31 run according to the second, third, fourth or sixth exemplary embodiment.

According to further exemplary embodiments of the active part 1, a third trajectory 31 corresponding to the sixth exemplary embodiment is provided in an active part 1 according to the first to fifth exemplary embodiments.

In the following, exemplary embodiments of a method for producing the active part 1 according to the preceding exemplary embodiments are described:

The method comprises a first step of providing the core 2 and the shaped conductors 6 inserted into the core 2. In a subsequent second step, two end areas 9 are joined together so that the two end areas 9 form a pair 10.

In a subsequent third step, each pair 10 is welded by means of a laser beam guided on the end areas 9 of the pair along the first trajectory 13 and the second trajectory and, if necessary, along the third trajectory 31 according to one of the previously described exemplary embodiments. A laser device generating the laser beam is used for this purpose. The laser device is operable in a deactivated state, in which the laser beam is switched off or has insufficient power to melt a material of the shaped conductors 6. The laser device is further operable in an activated state in which the laser beam can melt the material of the shaped conductor 6.

The third step of welding further comprises the following steps for each trajectory 13, 14, 31: aligning the laser device with the start point 13a, 14a, 31a of the trajectory 13, 14, 31 in the deactivated state; and guiding the laser beam in the activated state of the laser device from the start point 13a, 14a, 31a along the trajectory 13, 14, 31 to the end point of the trajectory 13b, 14b, 31b. Here, between the aligning and the guiding, the laser device is transferred from the deactivated state to the activated state when the laser device is aligned with the start point 13a, 14a, 31a of the trajectory 13, 14, 31, and is transferred from the activated state to the deactivated state when the guiding has reached the end point 13b, 14b, 31b of the trajectory.

Optionally, it can be provided that an energy input of the laser beam along the first trajectory 13 within the non-adjacent octants 23b1, 23c2 of the quadrants 23b, 23c in which the first trajectory 13 is located is greater than within the adjacent octants 23b2, 23c1 of the quadrants 23b, 23c in which the first trajectory 13 is located.

Accordingly, it can be provided that an energy input of the laser beam along the second trajectory 14 is greater within the non-adjacent octants 23a2, 23d1 of the quadrants 23a, 23d in which the second trajectory 14 lies than within the adjacent octants 23a1, 23d2 of the quadrants 23a, 23d in which the second trajectory 14 lies.

It should be noted that the active part 1 obtained by carrying out the method—depending on the parameterization of the welding process—does not necessarily have to have weld seams in the form of the trajectories.

FIG. 9 is a schematic sketch of a vehicle 100 with an exemplary embodiment of a rotary electric machine 101. The electric machine 101 comprises a stator 102 and a rotor 103. The stator 102 and/or the rotor 103 are formed as an active part 1 according to one of the previously described exemplary embodiments or are obtained by one of the previously described exemplary embodiments of the method.

The electric machine 101 is configured to drive the vehicle 100. Accordingly, the vehicle 100 is a battery electric vehicle (BEV) or a hybrid vehicle.

1. A method for producing an active part for a rotary electric machine, comprising:
providing a core for the active part and shaped conductors inserted into the core, wherein the core has an end face, a further end face opposite the end face, and a plurality of slots which are arranged circumferentially and in which the shaped conductors are arranged, wherein the shaped conductors extend from the end face to the further end face and each have a free end which protrudes at the end face and has an end area;
joining together, in each case, two of the end areas so that the two end areas form a pair; and
welding each pair of the end areas by a laser beam which is guided on the end areas of the pair along a first trajectory and a second trajectory, wherein the first trajectory and the second trajectory each have a start point and an end point which is different from the start point,
wherein the first trajectory and the second trajectory run concavely between the start point and the end point.

2. The method according to claim 1, wherein an edge of the end area of each shaped conductor consists of an inner edge portion and an outer edge portion, wherein the inner edge portion of one of the end areas of each pair runs along the inner edge portion of the other end area of the pair in question, and between the inner edge portions a boundary region, in particular formed by a gap between the inner edge portions or a contact of the inner edge portions, runs, formed by a gap between the inner edge portions or a contact of the inner edge portions, wherein each trajectory runs over an area at the edge of which the outer edge portions lie and which encloses the boundary region.

3. The method according to claim 2, wherein the midpoint of the first trajectory and of the second trajectory is closer to a midpoint of the area than the start point and the end point of the trajectory.

4. The method according to claim 2, wherein the area is subdivided into a first to fourth quadrant, wherein a common boundary line of the first and second quadrants and a common boundary line of the third and fourth quadrants lie on a first line and a common boundary line of the first and fourth quadrants and a common boundary line of the second and third quadrants lie on a second line intersecting the first line.

5. The method according to claim 4, wherein the start point and the end point of the first trajectory are located in two different quadrants lying on the same side of the first line, and the start point and the end point of the second trajectory are located in different quadrants lying on the other side of the first line.

6. The method according to claim 4, wherein the first line runs along the boundary portion.

7. The method according to claim 4, wherein the second line runs along the boundary portion.

8. The method according to claim 4, wherein the first trajectory and the second trajectory each run entirely within those quadrants in which the start point and the end point of the trajectory lie.

9. The method according to claim 4, wherein each quadrant is diagonally divided into two octants and a common boundary line of each two adjacent octants runs towards an intersection of the first line with the second line, wherein the first and second trajectories each extend over a greater distance within the non-adjacent octants of the quadrants in which the trajectory lies than within the adjacent octants of the quadrants in which the trajectory lies, and/or an energy input of the laser beam along the first and second trajectories within the non-adjacent octants of the quadrants in which the trajectory lies is greater than within the adjacent octants of the quadrants in which the trajectory lies.

10. The method according to claim 1, wherein the first and second trajectories each describe an arched curve, an arc of a circle, an arc of an ellipse, a parabola or a hyperbola, on the area or have or consist of first to third straight portions, wherein the first straight portion extends from the start point, the third straight portion extends towards the end point, and the second straight portion connects the first straight portion to the third straight portion.

11. The method according to claim 1, wherein the laser beam in the welding step is further guided along a third trajectory which lies, in particular without overlapping, between the first and second trajectories and has a start point and an end point which is different from the start point.

12. The method according to claim 1, wherein a laser device generating the laser beam is used, the laser device being operable in a deactivated state, in which the laser beam is switched off or has insufficient power for melting a material of the shaped conductors, and in an activated state, in which the laser beam can melt the material of the shaped conductors, wherein the step of welding comprises, for each trajectory:
aligning the laser device with the start point of the trajectory in the deactivated state;
guiding the laser beam in the activated state of the laser device from the start point along the trajectory to the end point of the trajectory,
wherein, between the aligning and the guiding, the laser device is transferred from the deactivated state to the activated state when the laser device is aligned with the start point of the trajectory, and is transferred from the activated state to the deactivated state when the guiding has reached the end point of the trajectory.

13. The method according to claim 1, wherein the active part is a stator or a rotor.

14. An active part for a rotary electric machine obtained by a method according to claim 1 comprising:
a core; and
shaped conductors inserted into the core,
wherein the core has an end face, a further end face opposite the end face, and a plurality of slots which are arranged circumferentially and in which the shaped conductors are arranged,
wherein the shaped conductors extend from the end face to the further end face and each have a free end which protrudes at the end face and which in each case has an end area, wherein each two of the end areas are joined together in such a way that the two end areas form a pair, wherein each pair of the end areas of the pair are welded along a first trajectory and a second trajectory on the end areas,
wherein the first trajectory and the second trajectory each have a start point and an end point which is different from the start point, wherein the first trajectory and the second trajectory run concavely between the start point and the end point.

15. A rotary electric machine comprising a first active part according to claim 14; and a second active part wherein the electric machine is configured to drive a vehicle.
